(19) United States
(12) Patent Application Publication
(10) Pub. No.: US 2002/0036560 A1
(43) Pub. Date: Mar. 28, 2002

(54) Detachable transformer

(76) Inventors: Cheng-Hsiu Lu, Taoyuan City (TW); Chen-Lung Sue, Taitung City (TW); Shao-An Lu, Bade City (TW); Chao-Jung Lin, Taoyuan City (TW); Chien-Ming Li, Taipei (TW); Kou-Chuan Wang, Taitung City (TW)

Correspondence Address: RABIN & CHAMPAGNE, PC, 1101 14TH STREET, NW, SUITE 500, WASHINGTON, DC, 20005, US

(21) Appl. No.: 09/894,892

(22) Filed: Jun. 29, 2001

(30) Foreign Application Priority Data
Sep. 28, 2000 (TW) 89120143

(51) Int. Cl. H01F 27/02

(52) U.S. Cl. 336/96

(57) ABSTRACT

A detachable transformer includes a high-voltage coil, an anti-splash cap, a low-voltage coil and a transformer body. The coupling chamber has a top end coupled to the anti-splash cap and a bottom end for matching the transformer body. It is assured that the filler can be encapsulated between the high-voltage coil and the transformer body. After the low-voltage coil and the iron core are inserted, the transformer is then formed. Furthermore, the anti-splash cap can be either separable from the coupling chamber or an integral part of the high-voltage coil. The anti-splash cap can also be replaced by an anti-splash sleeve, which is disposed in the high-voltage coil. This enhances the insulation effect of the high-voltage coil by encapsulating the filler in the gap and between the high-voltage coil and the transformer body.

This application incorporates by reference Taiwanese application Serial No. 089120143, Filed Sep. 28, 2000.

### BACKGROUND OF THE INVENTION

1. Field of the Invention

The invention relates in general to a transformer, and more particularly to a transformer with the coils capable of detached from the transformer body.

2. Description of the Related Art

With the rapid development of high technology, the electronic products trend towards compactness. Interior components of the electronic products have to be also minimized in size so as to develop smaller products. For instance, a modem monitor, which possesses a large market share, requires not only excellent image performance but also compactness. Generally speaking, the high-voltage component is a crucial component of a display system in the design of a monitor. A Cathode Ray Tube (CRT), for example, requires high voltage to draw or liberate electrons (negatively charged) from the cathode. The high-voltage component is therefore an indispensable component. The transformer for transforming low voltage into high voltage plays an important role to provide the high-voltage power. Hence, making the transformer small and efficient is an ongoing challenge and a main orientation of research and development nowadays.

An exploded view illustrating the structure of the conventional transformer is shown in FIG. 1. The assembly of the transformer is first illustrated as the following. The transformer 100 includes a low-voltage coil 110, high-voltage coil 120 and the transformer body 130. As shown in FIG. 1, the high-voltage coil 120 is a hollow structure with a coupling chamber 120a and the low-voltage coil 110 is a hollow structure as well. In the assembling process, the low-voltage coil 110 is inserted in the coupling chamber 120a to combine the low-voltage coil 110 and the high-voltage coil 120 together. On the other hand, the transformer body 130 should be a completely tubular hollow structure with a body chamber 130a. The cutaway view of the transformer body 130 shown in FIG. 1 is for making the drawing more distinguishable and clear. The illustrative way will be used in the following FIG. 3, FIG. 5 and FIG. 7 without restatement. After combining the low-voltage coil 110 and high-voltage coil 120, the entire ensemble can be put inside the body chamber 130a for the union of the low-voltage coil 110, high-voltage coil 120, and the transformer body 130. What needs to be noticed is that the transformer body 130 has an opening 130b for linking with the body chamber 130a. Therefore, the bottom of the low-voltage coil 110 can match the opening 130b while assembling. After the assembly is completed, it only requires inserting the iron core inside the low-voltage coil 110 and then the transformer 100 is formed.

Concerning the choice of the winding material, the finest winding shall be adopted to produce the high-voltage coil 120 to increase the number of circles of the winding in the limited space available and to produce the desired higher voltage. As the winding is fairly fine, the insulating layer attached outside of the winding is pretty thin. In the process of wrapping the winding around the high-voltage coil 120, the insulating effect is reduced greatly and the danger of electric leakage is increased due to the damage of the insulating layer attached externally of the winding by the pulling action.

For preventing the high-voltage coil 120 from reducing the insulating effect due to damage of the insulating layer and the workers from injury, the filler technique is utilized. Referring to FIG. 2, a cross-sectional view of the transformer 100 after being assembled is shown. According to the traditional manufacturing process, the combination of the low-voltage coil 110, high-voltage coil 120 and the body chamber 130a is consolidated by the matching of the bottom of the low-voltage coil 110 and the opening 130b. After assembly, the filler 210 is encapsulated into the body chamber 130a, wherein the filler 210 is a coagulable fluid insulating material. By encapsulating the filler 210 between the high-voltage coil 120 and the low-voltage coil 110, it enhances the wrapping effect of the winding and achieves the goal of insulation. Besides, the filler 210 can be entirely encapsulated inside the body chamber 130a without overflowing from the opening 130b since the bottom of the low-voltage 112 matches the opening 130b. The height of the encapsulated filler 210 is to the position of the low-voltage terminal 115 of the low-voltage coil 110. Hence, it ensures the winding of the low-voltage coil 110 is covered by the filler 210 to achieve the insulation effect. Furthermore, this strengthens the adhesion between the coils by utilizing the filler 210 as the medium for consolidation. After the filler 210 is encapsulated and solidified, the low-voltage coil 110 and the high-voltage coil 120 are consolidated in the body chamber 130a so that the whole structure of the transformer 100 becomes strengthened. To achieve the above-mentioned goal, of course, the filler 210 must be an excellent insulating material able to enter the smallest space and excellent solidification. There are several materials equipped with this requirement. The epoxy resin is generally used as the filler 210 by the industrial community.

In the conventional manufacturing process, the deficiency of tin-plating or the break-down of the stranded wire could cause the impedance of the direct current to be abnormal. If it can not be controlled properly during the manufacturing process, it would be too late to find the malfunction in the verification procedure since the transformer 100 and the winding are inseparable due to the adhesion of the filler 210. Hence, there is no alternative but to discard the product as junk. As for the low-voltage coil 110, the copper coil with 0uew standard is widely used as the winding, where the single insulating destructive voltage of the copper coil can endure more than 3.5 KV while the collector pulse (Vcp) in the low-voltage side of the conventional transformer 100 is lower than 1.5 KV. Compared to the high-voltage coil 120, the winding around the low-voltage coil 110 is thicker and the insulating layer attached externally of the winding of the low-voltage coil 110 is thicker as well. Therefore, it is not imperative to strengthen the insulation of the winding of the low-voltage coil 110 additionally in such rated voltage. Besides, for several large monitors, the PWM (Pulse Width Modulation) technology is adopted to increase the transformation rate of the transformer and the transistor with a lower VDS rated value is chosen as the Drive MOSFET of the monitor to reduce the cost of manufacture. Generally speaking, a VDS rated value of 600V is widely used. The rated value of the low-voltage side must be designed as about 600V to match up with the driving voltage of the MOSFET transformer while the collector pulse of the low-voltage side is about 650V The voltage value is less than a half of the original collector pulse, which is around 1.5 KV, as compared to the former structure of the transformer. Hence, it is not imperative to strengthen the insulation of the winding of the low-voltage coil 110 additionally in rated voltage under the conventional structure.

On the other hand, bubbles generated in the process of encapsulation may burst and the low-voltage terminal 115 may be stuck with glue. Once the epoxy solidifies, it may cause poor conduction of the low-voltage terminal 115.

Moreover, the low-voltage coil 110 and high-voltage coil 120 are firmly fixed in the body chamber 130a after the epoxy is encapsulated and solidifies. In case of defective products, the transformer 100 cannot be recycled but thrown away which is a waste of resources.

Furthermore, the transformers are designed according to individual standards of the high-voltage coil and the low-voltage coil by request of the clients. Without a standardized manufacturing process, it takes much time to design and operate. Since uncollected materials increase the stock cost, the cost of production increases correspondingly and the competitiveness of the product is then decreased.

Thus it can be seen that there are at least the following drawbacks due to the structural deficiencies of the conventional transformer.

First, the repair rate is low since the low-voltage coil and high-voltage coil are firmly fixed in the body chamber. In case that the low-voltage coil is damaged, the bad low-voltage coil cannot be replaced but the whole transformer has to be thrown away.

Second, it is a waste of the resources that the epoxy is encapsulated for both the low-voltage coil and high-voltage coil in the manufacturing process since there is no need to enhance the insulation of the low-voltage terminal in the present design.

Third, without a standardized manufacturing process, each transformer has to be custom designed according to the standards of the high-voltage coil and the low-voltage coil as requested by each client. A lot of time is spent on design and operation that the competitiveness of the product is decreased.

Fourth, quality control is not easy since the bubbles' bursting makes the low-voltage terminal open while encapsulating thus reducing the yield rate of the products.

Fifth, it causes environmental problems since the coils are firmly fixed inside the body chamber and the copper windings wrapped around the high-voltage coil cannot be recycled.

Consequently, the high-voltage coil is able to be fixed inside the transformer body for encapsulating the filler. It requires that the height of the encapsulated filler be lower than that of the anti-splash cap. This prevents the filler from entering inside the high-voltage coil by the protection of the anti-splash cap in the process of encapsulating the filler. It is assured that the filler can be encapsulated between the high-voltage coil and the transformer body. After the low-voltage coil is inserted in the high-voltage coil and the iron core is inserted in the low-voltage coil, the transformer is then formed. The anti-splash cap can be either separable from the coupling chamber or an integral part of the high-voltage coil. The anti-splash cap can also be replaced by an anti-splash sleeve, which is an extended form of the anti-splash cap and disposed in the high-voltage coil. This enhances the insulation effect of the high-voltage coil by encapsulating the filler in the gap and between the high-voltage coil and the transformer body.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 is an exploded view illustrating the structure of each part of the conventional transformer;

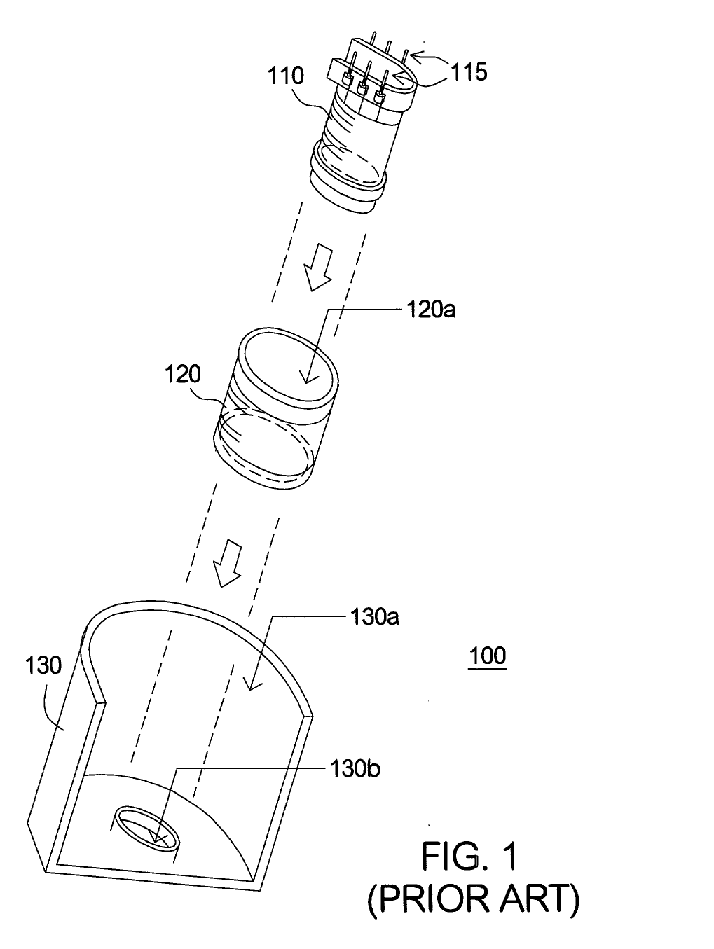

FIG. 2 shows a cross-sectional view of the transformer after being assembled in FIG. 1;

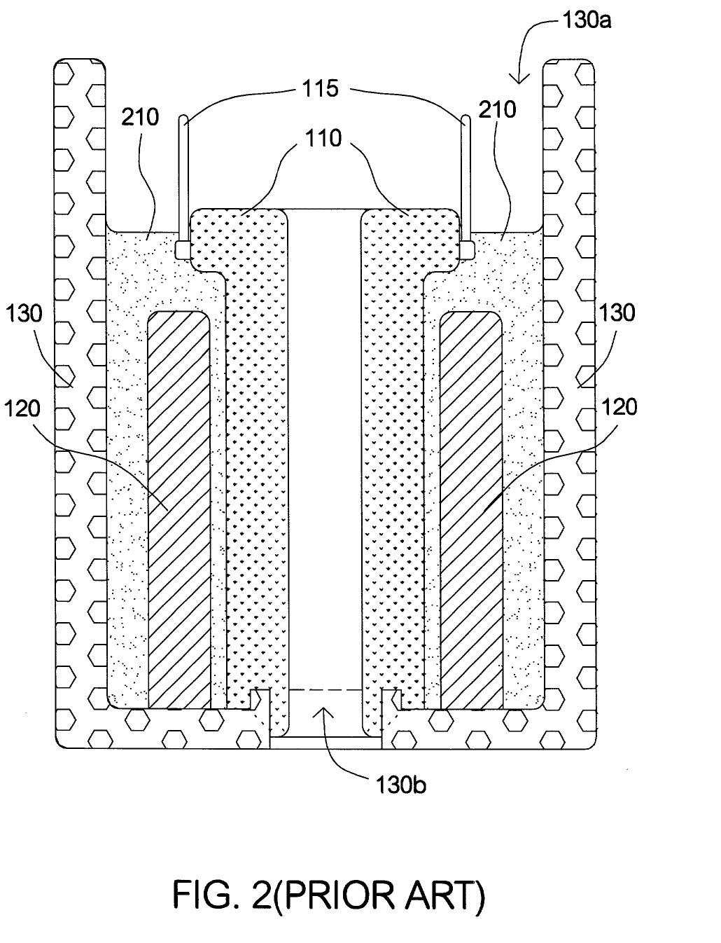

FIG. 3 shows an exploded view of a detachable transformer according to the first preferred embodiment of the invention;

FIG. 4a is a cross-sectional view showing the structure of a detachable transformer according to the first preferred embodiment of the invention;

FIG. 4b shows a cross-sectional view of another anti-splash cap coupling with the high-voltage coil in the first preferred embodiment;

FIG. 5 shows an exploded view of a detachable transformer according to the second preferred embodiment of the invention;

FIG. 6 is a cross-sectional view showing the structure of a detachable transformer according to the second preferred embodiment of the invention;

FIG. 7 shows an exploded view of a detachable transformer according to the third preferred embodiment of the invention; and

FIG. 8 is a cross-sectional view showing the structure of a detachable transformer according to the third preferred embodiment of the invention.

### DESCRIPTION OF THE PREFERRED EMBODIMENT

The detachable transformer according to the invention utilizes a special design of the anti-splash cap disposed on top of the high-voltage coil to ensure the encapsulation of the filler between the transformer body and the high-voltage coil. Therefore, the low-voltage coil is inserted after the filler is encapsulated so that the low-voltage coil is detachable. The preferred embodiments are stated as followed:

### EXAMPLE 1

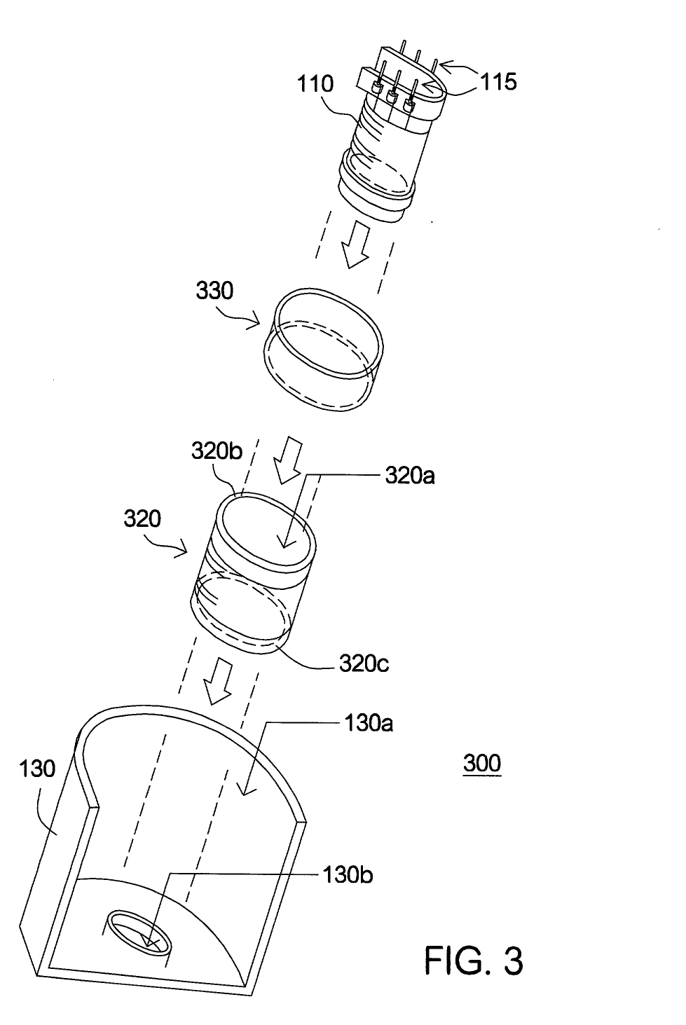

Referring to FIG. 3, an exploded view of a detachable transformer according to the first preferred embodiment of the invention is shown. The detachable transformer 300 includes a high-voltage coil 320, an anti-splash cap 330, a low-voltage coil 110 and the transformer body 130. As shown in FIG. 3, the high-voltage coil 120 is a hollow structure with a coupling chamber 320a. The coupling chamber 320a has a top end 320b and a bottom end 320c. In the assembly process, the anti-splash cap 330 forms on the top end 320b of the coupling chamber 320a by mortising, wedging, or buckling. Therefore, the anti-splash cap 330 is separable from the coupling chamber 320a.

Subsequently, the assembly of the high-voltage coil 320 and the transformer body 130 is proceeded. The transformer body 130 has a body chamber 130a and an opening 130b with rim. After mounting the anti-splash cap 330 on the high-voltage coil 320, the high-voltage coil 320 can be fixed in the body chamber 130a by the match of the opening 130b with rim and the bottom end 320c of the coupling chamber 320a. Of course the high-voltage coil 320 can be first fixed in the body chamber 130a and then combined with the anti-splash cap 330 without ill effect. After the high-voltage coil 320 is consolidated in the transformer body 130 and the anti-splash cap 330 is mounted on the top end 320b of the coupling chamber 320a, the filler can be encapsulated.

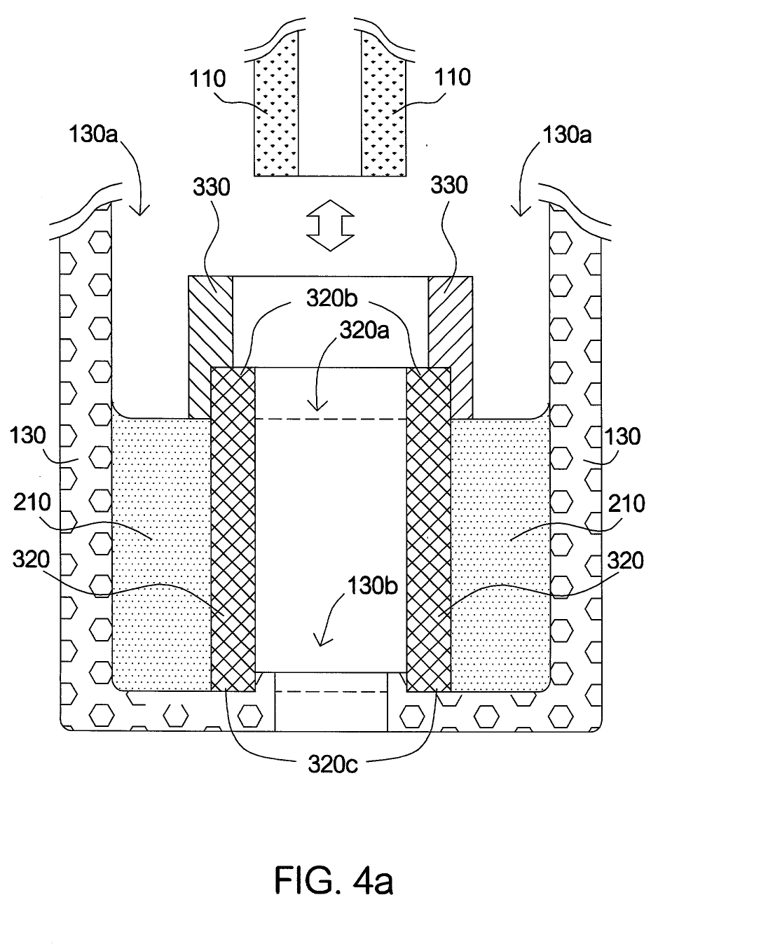

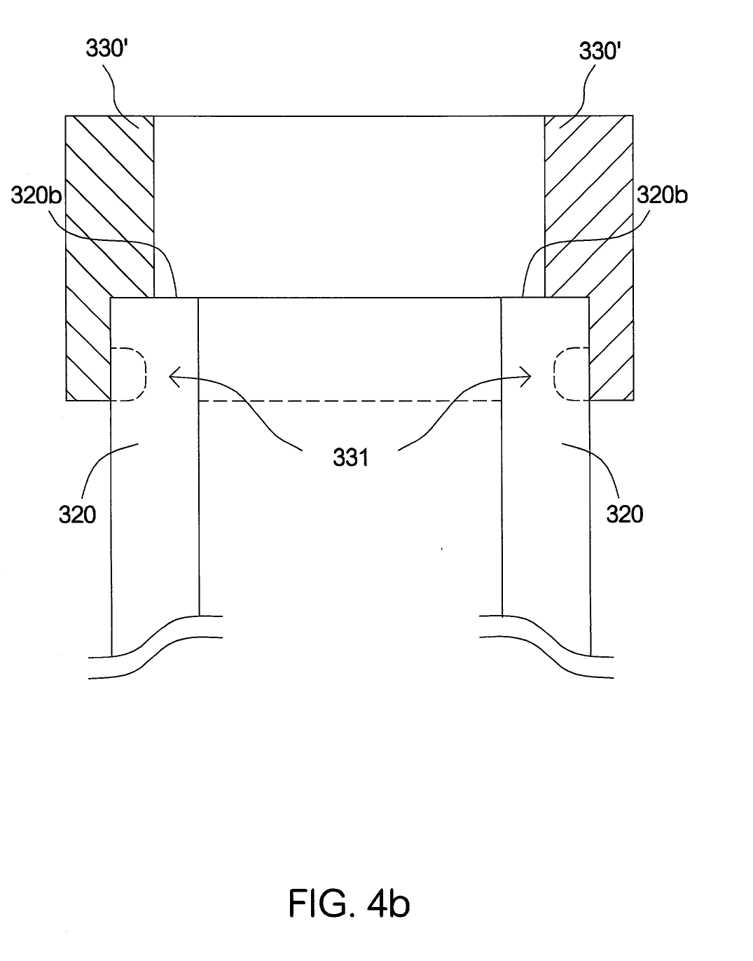

Referring to FIG. 4a, a cross-sectional view showing the structure of a detachable transformer according to the first preferred embodiment of the invention is illustrated. The anti-splash cap 330 is mounted on top end 320b of the coupling chamber 320a; the filler is encapsulated between the high-voltage coil 320 and the body chamber 130a. The filler 210 can be epoxy or other similar material. Since the anti-splash cap is mounted on the top of the high-voltage coil 320 and the height of the encapsulated filler 210 is lower than that of the anti-splash cap 330, the filler 210 is prevented from entering the coupling chamber 320a by the protection of the anti-splash cap 330 in the process of encapsulating the filler 210. On the other hand, the filler 210 can be entirely encapsulated between the high-voltage coil 320 and the body chamber 130a without overflowing from the opening 130b since the bottom 320c of the coupling chamber 320a matches opening 130b with rim for consolidating the high-voltage coil 320 and the transformer body 130.

Referring to FIG. 4b, a cross-sectional view of another anti-splash cap coupling with the high-voltage coil in the first preferred embodiment is shown. As shown in FIG. 4b, the anti-splash cap 330′ is an altered form of the anti-splash cap 330. The anti-splash cap 330′ has a protrusion 331. Shaped with a cavity near the top end 320b of the coupling chamber 320a, the protrusion 331 is wedged in the cavity so that the anti-splash cap 330′ is tightly mounted on the top end 320b of the coupling chamber 320a. The detachable method of wedging can be replaced by mortising or buckling without departing from the spirit and scope of this invention.

After the filler 210 is encapsulated, the low-voltage coil 110 is inserted into the coupling chamber 320a. Since the low-voltage coil 110 is a hollow structure, it is only required that the iron core be inserted inside the low-voltage coil 110 from the opening 130b to complete the assembly of the transformer 100. It is the feature of the structure that the low-voltage coil 110 can be easily detached from the high-voltage coil 320 even though the filler 210 has been encapsulated. Whenever the low-voltage coil 110 is found to be damaged during quality controlling, the transformer 100 can be repaired by the replacement of the low-voltage coil 110 instead of being thrown away. The repair rate of the product is consequently increased.

Besides, this transformer structure standardizes the manufacturing process. The standardized semi-finished goods can be first manufactured by fixing the high-voltage coil 320 in the body chamber 130a and encapsulating the filler 210 for consolidation. It is only required to redesign the low-voltage coil according to the specification requested by the client and matching the semi-finished goods with different low-voltage coil to produce transformers with different voltage ratings. This reduces the time spent on design and also greatly decreases the stock cost due to uncollected materials.

### EXAMPLE 2

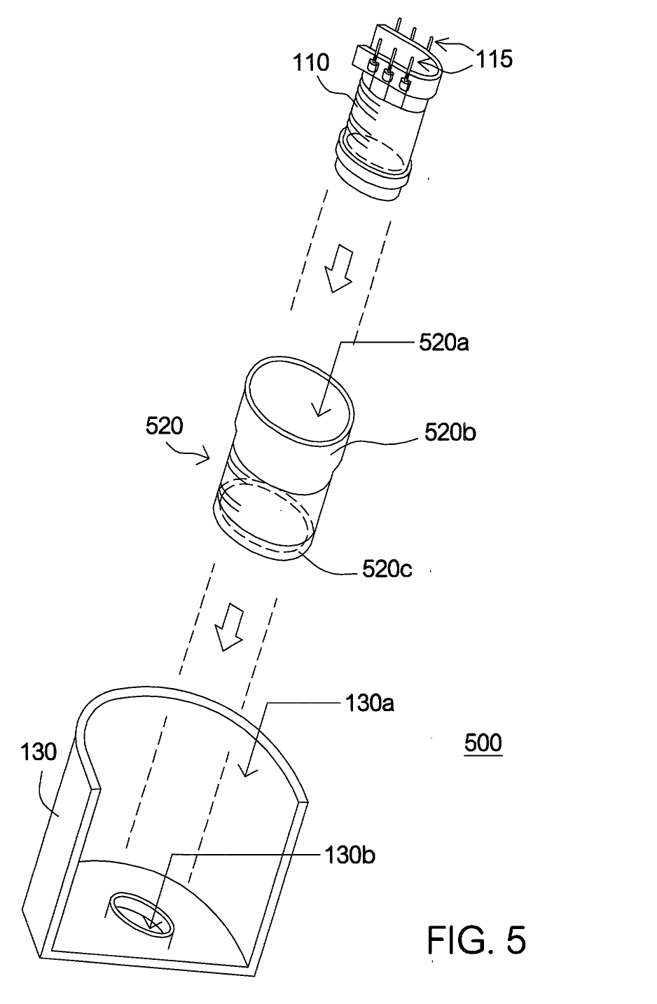

Referring to FIG. 5, an exploded view of a detachable transformer according to the second preferred embodiment of the invention is shown. The detachable transformer 500 includes a high-voltage coil 520, a low-voltage coil 110, and the transformer body 130. As shown in FIG. 5, the high-voltage coil 520 is a hollow structure with a coupling chamber 520a. One end of the coupling chamber 520a is the anti-splash cap 520b while the other end is the bottom end 520c of the coupling chamber 520a. The anti-splash cap 520b is an integral part of the high-voltage coil 520 and inseparable from the coupling chamber 520a. The transformer body 130 is also a hollow structure and has a body chamber 130a and an opening 130b with rim. In the process of assembly, the high-voltage coil 520 is firmly fixed in the body chamber 130a by the match of the opening 130b with rim and the bottom 520c of the coupling chamber 520a. The filler can be sequentially encapsulated.

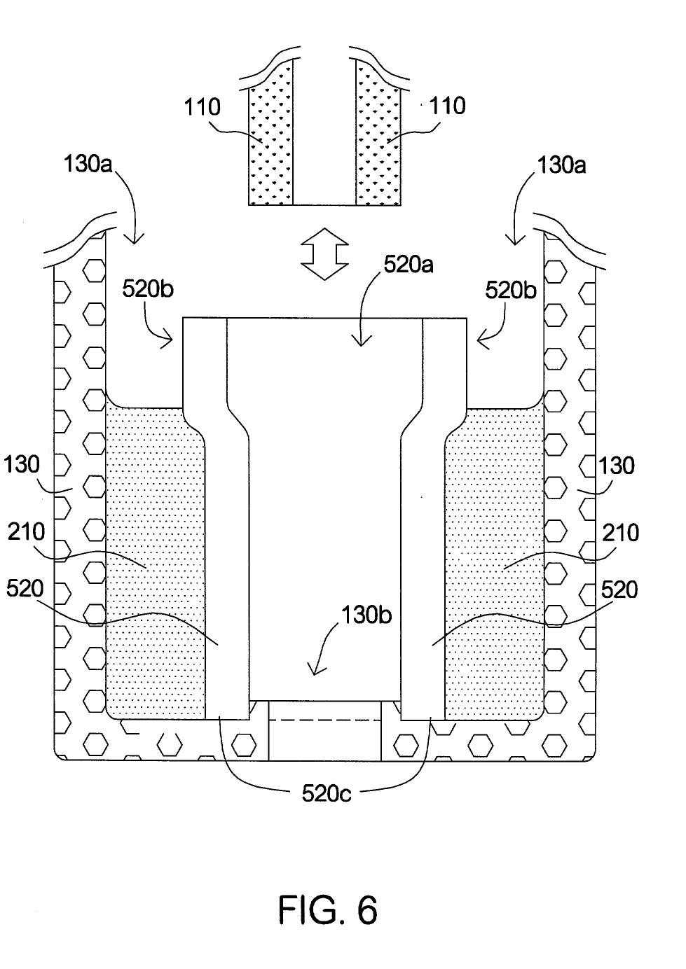

Referring to FIG. 6, a cross-sectional view showing the structure of a detachable transformer according to the second preferred embodiment of the invention is illustrated. The filler is encapsulated between the high-voltage coil 520 and the body chamber 130a. The filler 210 can be epoxy or other similar material. Since the top of the high-voltage coil 520 is the anti-splash cap 520b and the height of the encapsulated filler 210 is lower than that of the anti-splash cap 520b, the filler 210 is prevented from entering the coupling chamber 520a by the protection of the anti-splash cap 520b in the process of encapsulating the filler 210. On the other hand, the filler 210 can be entirely encapsulated between the high-voltage coil 520 and the body chamber 130a without overflowing from the opening 130b since the bottom end 520c of the coupling chamber 520a matches the opening 130b with rim for consolidating the high-voltage coil 520 and the transformer body 130. Of course, the appearance of the anti-splash cap 520b is not limited to that in FIG. 5 or FIG. 6 of course. Any person skilled in the art can design the anti-splash cap with other geometric shape to achieve the above-mentioned effect without departing from the spirit and scope of this invention.

After the filler 210 is encapsulated, the low-voltage coil 110 is inserted into the coupling chamber 520a. Since the low-voltage coil 110 is a hollow structure, it is only required that the iron core be inserted inside the low-voltage coil 110 from the opening 130b to complete the assembly of the transformer 100. It is the feature of the structure that the low-voltage coil 110 can be easily detached from the high-voltage coil 520 even though the filler 210 has been encapsulated. Whenever the low-voltage coil 110 is found damaged during quality control, the transformer 100 can be repaired by replacing of the low-voltage coil 110 instead of being thrown away. The repair rate the product is consequently increased.

Besides, this transformer structure standardizes the manufacturing process. The standard semi-finished goods can be first manufactured by fixing the high-voltage coil 520 in the body chamber 130a and encapsulating the filler 210 for consolidation. Then, only the low-voltage coil needs to be custom designed to the specification requested by the client to produce transformers with different voltage ratings. This reduces design time and also greatly decreases the stock cost due to uncollected materials.

### EXAMPLE 3

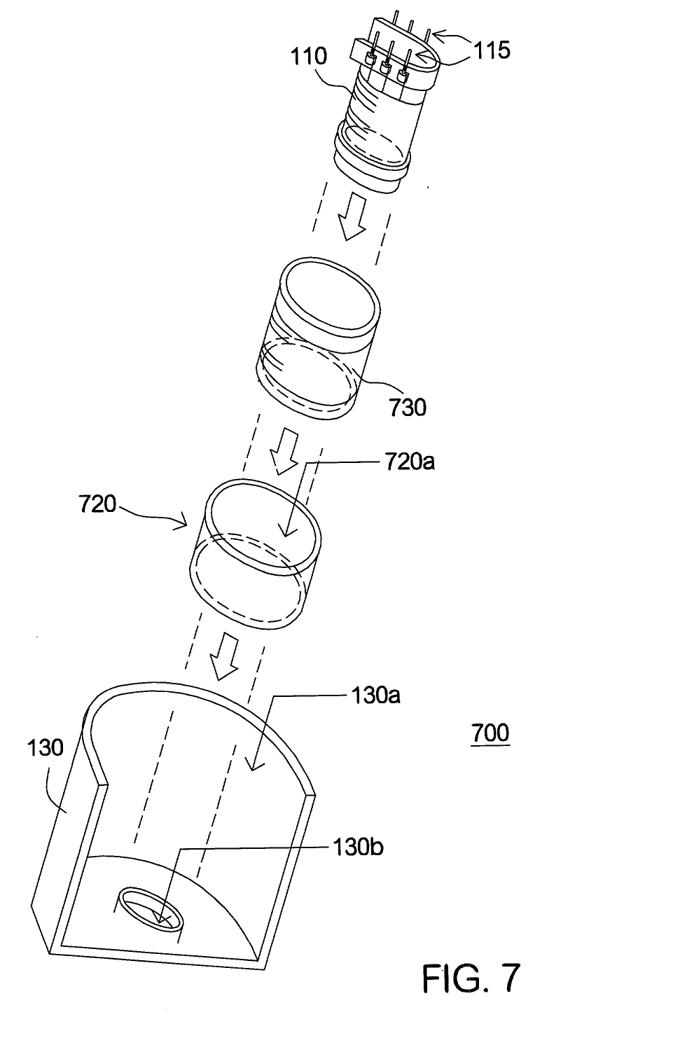

Referring to FIG. 7, an exploded view of a detachable transformer according to the third preferred embodiment of the invention is shown. The detachable transformer 700 includes a high-voltage coil 720, an anti-splash sleeve 730, a low-voltage coil 110 and the transformer body 130. As shown in FIG. 7, the high-voltage coil 720 is a hollow structure with a coupling chamber 720a. The transformer body 130 is also a hollow structure with a body chamber 130a and an opening 130b with rim. During assembly, the anti-splash sleeve 730 is first inserted in the coupling chamber 720a. The combined anti-splash sleeve 730 and high-voltage coil 720 are then inserted in the body chamber 130a. The internal diameter of the coupling chamber 720a is larger than the external diameter of the anti-splash sleeve 730 so that the opening 130b with rim matches the anti-splash sleeve 730. In this way, the high-voltage coil 720 is disposed in the body chamber 130a and the anti-splash sleeve 730 is disposed in the coupling chamber 720a spaced a gap l apart with the high-voltage coil 720. The anti-splash sleeve 730, high-voltage coil 720, and transformer body 130 are integrated by the match of the opening 130b with rim and the anti-splash sleeve 730.

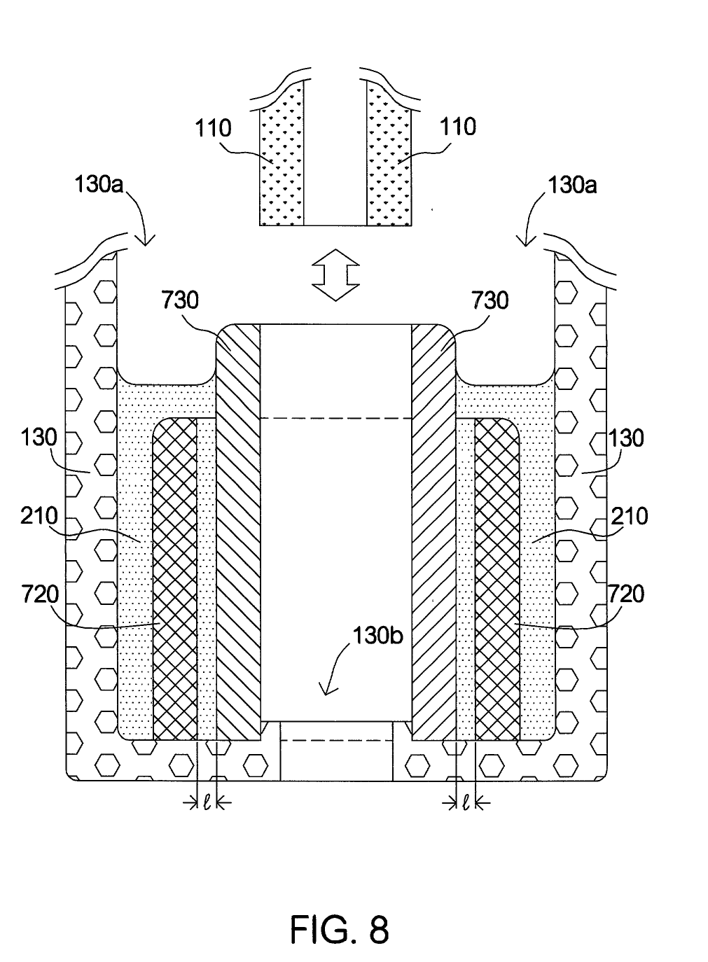

Referring to FIG. 8, a cross-sectional view showing the structure of a detachable transformer according to the third preferred embodiment of the invention is illustrated. The anti-splash sleeve 730 wedges the opening 130b with rim and is spaced a gap 1 apart with the high-voltage coil 720. The filler 210 is encapsulated between the high-voltage coil 720 and the body chamber 130a and in the gap 1. The filler 210 can be epoxy or other similar material. Since the height of the encapsulated filler 210 is lower than that of the anti-splash sleeve 730, it prevents the filler 210 from entering inside the anti-splash sleeve 730 by the protection of the anti-splash sleeve 730 in the process of encapsulating the filler 210. On the other hand, the filler 210 can be entirely encapsulated between the high-voltage coil 720 and the body chamber 130a and in the gap 1 without overflowing from the opening 130b since the anti-splash sleeve 730 matches the opening 130b with rim for consolidating the high-voltage coil 320 and the transformer body 130.

After the filler 210 is encapsulated, the low-voltage coil 110 is inserted into the anti-splash sleeve 730. Since the low-voltage coil 110 is a hollow structure, it is only required that the iron core be inserted inside the low-voltage coil 110 from the opening 130b to complete the assembly of transformer 100. It is the feature of the structure that the low-voltage coil 110 can be easily detached from the high-voltage coil 720 even though the filler 210 has been encapsulated. Whenever the low-voltage coil 110 is found damaged during the quality control, the transformer 100 can be repaired by replacing the low-voltage coil 110 instead of being thrown away. Furthermore, both the outside and inside of the high-voltage coil 720 are covered by the filler 210 to enhance the insulation effect.

Moreover, this transformer structure standardizes the manufacturing process. The standardized semi-finished goods can be first manufactured by fixing the anti-splash sleeve 730 and the high-voltage coil 720 in the body chamber 130a and encapsulating the filler 210 for consolidation. It is only required that the low-voltage coil be custom designed according to the specification requested by the client and matching the semi-finished goods with different low-voltage coils to produce transformer with different voltage ratings. This reduces design time and greatly decreases the stock cost due to uncollected materials.

What needs to be noticed is that each part of the geometric structures in the above-mentioned is an example to provide a thorough and complete disclosure. Modifications and substitutions may be made by any person skilled in the art to achieve the above-mentioned effect without departing from the spirit and scope of this invention.

The detachable transformer according to the preferred embodiment of the invention at least has the following advantages:

First, the repair rate of the product is increased because the low-voltage coil can be detached from the body chamber. In case that the low-voltage coil is damaged, the transformer can be repaired by replacing the low-voltage coil instead of being thrown away.

Second, it avoids wasting the resources. The epoxy is only encapsulated for the high-voltage coil in the manufacturing process since there is no need to enhance the insulation of the low-voltage terminal.

Third, it standardizes the manufacturing process. The high-voltage coil is fixed in the transformer body and filled with epoxy by standard design. It is only required that the low-voltage coil be custom designed according to the specification requested by the client. This reduces design and operation times so that the competitiveness of the product is enhanced.

Fourth, it makes quality control easy. The epoxy is encapsulated before the low-voltage coil is inserted in the transformer. It does not cause the low-voltage terminal to be opened. Hence, the yield rate of the products increases.

Fifth, it endeavors to protect the environment. The low-voltage coil can be easily detached from the body chamber and the wrapped copper winding can thus be recycled.

While the invention has been described by way of example and in terms of the preferred embodiment, it is to be understood that the invention is not limited to the disclosed embodiment. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A detachable transformer, comprising:
a high-voltage coil having a coupling chamber, wherein the coupling chamber has a top end and a bottom end;
an anti-splash cap forming on the top end of the coupling chamber;
a low-voltage coil disposed in the coupling chamber;
a transformer body having a body chamber, wherein the high-voltage coil, anti-splash cap, and low-voltage coil are disposed in the body chamber; and
a filler, which is encapsulated between the high-voltage coil and the body chamber.

2. The detachable transformer according to claim 1, wherein the transformer body further has an opening with rims for matching the bottom end of the coupling chamber.

3. The detachable transformer according to claim 1, wherein the anti-splash cap is separable from the coupling chamber.

4. The detachable transformer according to claim 3, wherein the anti-splash cap is forming on the top end of the coupling chamber by mortising.

5. The detachable transformer according to claim 3, wherein the anti-splash cap is forming on the top end of the coupling chamber by wedging.

6. The detachable transformer according to claim 3, wherein the anti-splash cap is forming on the top end of the coupling chamber by buckling.

7. The detachable transformer according to claim 1, wherein the anti-splash cap is an integral part of the high-voltage coil and inseparable from the coupling chamber.

8. The detachable transformer according to claim 1, wherein the filler is epoxy resin.

9. A detachable transformer, comprising:
a high-voltage coil having a coupling chamber;
an anti-splash sleeve disposed in the coupling chamber and spaced a gap apart with the high-voltage coil;
a low-voltage coil disposed in the anti-splash sleeve;
a transformer body having a body chamber, wherein the high-voltage coil, the anti-splash sleeve and the low-voltage coil are disposed in the body chamber; and
a filler, which is encapsulated between the high-voltage coil and the body chamber and in the gap.

10. The detachable transformer according to claim 9, wherein the transformer body further has an opening with rim for matching the anti-splash sleeve.

11. The detachable transformer according to claim 9, wherein the filler is epoxy resin.
